(19) United States
(12) Patent Application Publication
(10) Pub. No.: US 2026/0107965 A1
(43) Pub. Date: Apr. 23, 2026

(54) THREE-DIMENSIONAL FOOD ITEM PRINTING SYSTEM AND THREE-DIMENSIONAL FOOD ITEM PRINTING METHOD

(71) Applicant: TOP TABLE INC., Seoul (KR)

(72) Inventor: Hyun Ju YOO, Seoul (KR)

(73) Assignee: TOP TABLE INC., Seoul (KR)

(21) Appl. No.: 19/423,992

(22) Filed: Dec. 17, 2025

Related U.S. Application Data
(63) Continuation of application No. PCT/KR2024/008514, filed on Jun. 20, 2024.

(30) Foreign Application Priority Data
Jun. 21, 2023 (KR) 10-2023-0079356
Jun. 19, 2024 (KR) 10-2024-0079441

(51) Int. Cl. A23P 20/20; A21C 11/16; A21D 8/02; A23C 15/02; A23C 19/076; A23G 1/00; A23G 1/20; A23G 3/02; A23G 3/34; A23L 7/109; A23L 19/00; A23L 19/12; A23L 21/10; A23P 20/25; B33Y 10/00; B33Y 30/00; B33Y 50/02

(52) U.S. Cl. CPC A23P 20/20; A21C 11/16; A21D 8/02; A23C 15/02; A23C 19/076; A23G 1/0063; A23G 1/205; A23G 3/0025; A23G 3/0252; A23L 7/109; A23L 19/09; A23L 19/13; A23L 21/10; B33Y 10/00; B33Y 30/00; B33Y 50/02; A23P 2020/253

(57) ABSTRACT

The present disclosure provides a three-dimensional food printing method which improves printing quality and enhances user convenience. The three-dimensional food printing method includes receiving an input of a two-dimensional image from a user terminal, generating a three-dimensional modeling file based on the input two-dimensional image, receiving an input of a type of a formulation including food ingredients from the user terminal, determining output parameters corresponding to the type of the formulation, generating printing command data by performing slicing based on the determined output parameters and the generated three-dimensional modeling file, and transmitting the printing command data to a three-dimensional food printing device.

### CROSS-REFERENCE TO RELATED APPLICATIONS

This application is a continuation of International Application No. PCT/KR2024/008514 filed on Jun. 20, 2024, which claims priority to Korean Patent Application No. 10-2023-0079356 filed on Jun. 21, 2023 and Korean Patent Application No. 10-2024-0079441 filed on Jun. 19, 2024, the entire contents of which are herein incorporated by reference.

### TECHNICAL FIELD

The present disclosure relates to a three-dimensional food printing system and a three-dimensional food printing method.

### BACKGROUND ART

Three-dimensional printing is a technology that produces three-dimensional products by shaping raw ingredients based on three-dimensional blueprints and computer technologies. Although materials such as plastics and metals have been most commonly used in three-dimensional printing, food printing, which uses food ingredients to three-dimensionally print food, has recently been attracting attention as a future leading industry.

Three-dimensional food item printing or three-dimensional food printing refers to the concept of using edible ingredients as ink of a printer to extrude food ingredients to create desired shapes or designs. Recently, research has been conducted to attempt three-dimensional food printing using various food ingredients. However, in a process of manufacturing food by extruding paste-type food ingredients, since resolution varies according to a nozzle size, an extrusion speed, and a nozzle movement speed, it is very difficult to set optimal printing conditions. In addition, in the case of food ingredients, of which flowability changes significantly according to a temperature, such as chocolate, butter, and starch-containing pastes, a nozzle temperature is also an important printing condition. For example, in the case of chocolate, there are many different types of chocolate according to the content of cocoa beans or additives, and it is also very difficult to set the optimal printing temperature for these different types of chocolate. Therefore, there is an increasing demand to provide optimal printing parameters for food ingredients.

### DISCLOSURE OF INVENTION

### Technical Problem

One of the objects to be solved by the present disclosure is to provide a three-dimensional food printing system and a three-dimensional food printing method which improve printing quality and enhance user convenience.

The objects to be solved by the present disclosure are not limited to the above-described objects, and other objects and advantages of the present disclosure, which are not described above, may be understood by the following description and more clearly understood than the embodiments of the present disclosure. In addition, it will be appreciated that the objects and advantages to be solved by the present disclosure may be realized by means and combinations thereof shown in the claims of the patent.

### Solution to Problem

According to an aspect of the present disclosure, provided is a three-dimensional food printing method of a three-dimensional food printing system including a user terminal, a platform server, and a three-dimensional food printing device, the three-dimensional food printing method including receiving an input of a two-dimensional image from the user terminal, generating a three-dimensional modeling file based on the input two-dimensional image, receiving an input of a type of a formulation including food ingredients from the user terminal, determining output parameters corresponding to the type of the formulation, generating printing command data by performing slicing based on the determined output parameters and the generated three-dimensional modeling file, and transmitting the printing command data to the three-dimensional food printing device, wherein each operation is performed by the platform server.

Here, the output parameters may include at least one selected from the group consisting of a nozzle size, a flow, a nozzle temperature, and a printing speed.

Here, the type of the formulation may include one selected from the group consisting of chocolate, dough, a fruit and vegetable paste, a sugar paste, and a dairy product.

Here, the output parameters of the formulation may include a nozzle size indicating a diameter of 0.5 mm to 1.5 mm, a flow of 45% to 75%, a nozzle temperature of 23° C. to 42° C., and a printing speed of 15 mm/s to 35 mm/s.

Here, the determining of the output parameters may include preparing training data including printing parameters for a formulation, a formula corresponding thereto, and a high-quality printing result, training an artificial intelligence model by using the prepared training data, and determining the output parameters based on a formula corresponding to a type of an input formulation through the trained artificial intelligence model.

Here, the formula may include at least one of a type of a food ingredient, a ratio of the food ingredient (for example, a weight ratio), or a manufacturing temperature.

According to another aspect of the present disclosure, provided is a three-dimensional food printing system including a user terminal, a platform server, and a three-dimensional food printing device, wherein the user terminal is configured to receive an input of a two-dimensional image from a user and receive an input of a type of a formulation including food ingredients, the platform server is configured to generate a three-dimensional modeling file based on the two-dimensional image input from the user terminal, determine output parameters corresponding to the type of the input formulation, generate printing command data by performing slicing based on the selected output parameters and the generated three-dimensional modeling file, and transmit the generated printing command data, and the three-dimensional food printing device is configured to print three-dimensional food based on the printing command data received from the platform server.

### Advantageous Effects of Invention

According to the means for solving the problems of the present disclosure described above, by providing a system or method for automatically providing optimal parameters for three-dimensional printing according to a type of a formulation consisting of food ingredients, there is an effect of improving printing quality and allowing even beginners to easily use the system.

According to another means for solving the problems of the present disclosure, a single solution is provided to perform the entire process including modeling, slicing, and printing commands based on input data received from a user, thereby obtaining an effect of enabling one-stop three-dimensional food printing to improve user convenience.

According to another means for solving the problems of the present disclosure, there is an effect in which even beginners may easily print three-dimensional food through a modeling process in which a three-dimensional shape is automatically generated when a user inputs only a two-dimensional shape.

According to another means for solving the problems of the present disclosure, since input data of a user may be stored in a platform server, the user may print three-dimensional food through a selected three-dimensional food printing device by using the platform server without any restrictions on place or time.

### BRIEF DESCRIPTION OF DRAWINGS

FIG. 1 is a schematic diagram illustrating a three-dimensional food printing system (hereinafter, “system”) according to an embodiment of the present disclosure.

FIG. 2 is a flowchart illustrating a three-dimensional food printing method using the system of FIG. 1.

FIG. 3 is an example of a home screen of a solution according to an embodiment of the present disclosure.

FIG. 4 is an example of a modeling screen of a solution according to an embodiment of the present disclosure.

FIG. 5 is an example of a slicing screen of a solution according to an embodiment of the present disclosure.

FIG. 6 is an example of a printer expansion list screen when a printer selection unit is selected on the slicing screen of FIG. 5.

FIGS. 7A and 7B are examples of a formulation expansion list screen when a formulation selection unit is selected on the slicing screen of FIG. 5.

FIG. 8 is a flowchart illustrating an operation of determining output parameters of FIG. 2 according to an embodiment in detail.

FIGS. 9A and 9B are examples of a library screen of a solution according to an embodiment of the present disclosure.

FIG. 10 is a block diagram of a platform server according to an embodiment.

### DETAILED DESCRIPTION OF THE INVENTION

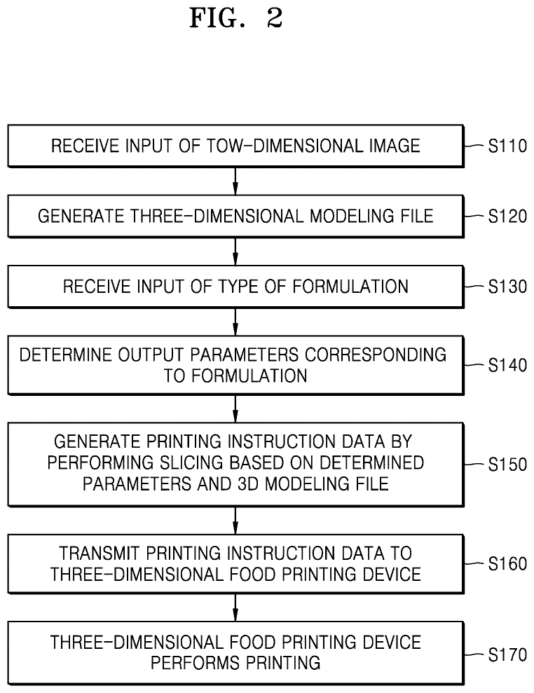

According to an aspect of the present disclosure, referring to FIG. 2, provided is a three-dimensional food printing method of a three-dimensional food printing system including a user terminal, a platform server, and a three-dimensional food printing device, the three-dimensional food printing method including receiving an input of a two-dimensional image from the user terminal, generating a three-dimensional modeling file based on the input two-dimensional image, receiving an input of a type of a formulation including food ingredients from the user terminal, determining output parameters corresponding to the type of the formulation, generating printing command data by performing slicing based on the determined output parameters and the generated three-dimensional modeling file, and transmitting the printing command data to the three-dimensional food printing device, wherein each operation is performed by the platform server.

### MODE FOR THE INVENTION

The advantages and features of the present disclosure and methods of accomplishing the same will become apparent from the following description of the embodiments in detail, taken in conjunction with the accompanying drawings. However, it should be understood that the present disclosure is not limited to the embodiments presented below, but may be implemented in various other forms and includes all transformations, equivalents, and substitutes included in the spirit and scope of the present disclosure.

Terms used in the present specification are merely used to describe specific embodiments and are not intended to limit the present disclosure. An expression used in the singular encompasses the expression of the plural, unless it has a clearly different meaning in the context. In the present application, the words “comprise” or “has” is used to specify existence of a feature, a number, a process, an operation, a constituent element, a part, or a combination thereof, and it will be understood that existence or additional possibility of one or more other features or numbers, processes, operations, constituent elements, parts, or combinations thereof are not excluded in advance.

It should be understood that any numerical range cited in the present disclosure is intended to include all subranges subsumed therein. For example, a range of “25° C. to 27° C.” includes, for example, all subranges and specific values between the stated minimum value of 25° C. and the stated maximum value of 27° C. such as 25° C. to 26° C., 25.5° C. to 26.5° C., 25° C., or 27° C. Since the disclosed numerical ranges are continuous, they include each numerical value between the minimum value and the maximum value. In addition, unless otherwise specified, the various numerical ranges indicated herein are approximate.

When the term “about” is used in connection with a numerical value in the present specification, unless otherwise explicitly stated, the related numerical value is intended to include a tolerance of +10% around the stated numerical value.

When weight ratios are described in the present specification, a weight of 1 ml of water is considered to be approximately 1 g.

In the present specification, a specific nozzle size (first nozzle size, second nozzle size, or the like), a specific flow (first flow, second flow, or the like), a specific temperature (first temperature, second temperature, or the like), a specific printing speed (first printing speed or second printing speed) may refer to a specific one numerical value or may be a term representing a “numerical range” that includes a set of continuous numerical values between a minimum value and a maximum value.

The term “diameter” as used herein refers to an average diameter.

The term “paste” as used herein refers to a dough-like viscous material and refers to a material having properties such as viscosity, mixability, and plasticity.

Some embodiments of the present disclosure may be represented by functional block configurations and various processing operations. Some or all of the functional blocks may be implemented in various numbers of hardware and/or software configurations that perform particular functions. For example, the functional blocks of the present disclosure may be implemented by one or more microprocessors or by circuit configurations for a given function. In addition, for example, the functional blocks of the present disclosure may be implemented in various programming or scripting languages. The functional blocks may be implemented in an algorithm executed by one or more processors. In addition, the present disclosure may adopt the related art for electronic configuration, signal processing, and/or data processing. Terms, such as “mechanism,” “element,” “means,” and “configuration” may be used widely and are not limited to mechanical and physical configurations.

Furthermore, connecting lines or connection members between components shown in the drawings are intended to represent functional connections and/or physical or logical connections. In an actual device, connections between components may be represented by various alternative or additional functional connections, physical connections, or circuit connections.

As used below, an action performed by a user may refer to an action carried out by the user through a user terminal U. As an example, a command corresponding to an action performed by a user may be input into the user terminal U through an input device (for example, a keyboard or a mouse) embedded in or additionally connected to the user terminal U. As another example, a command corresponding to an action performed by a user may be input to the user terminal U through a touch screen of the user terminal U. In this case, actions performed by a user may include certain gestures. For example, gestures may include tapping, touch-and-hold, double-tapping, dragging, panning, flicking, drag-and-drop, and the like.

Hereinafter, the present disclosure will be described in detail with reference to the accompanying drawings.

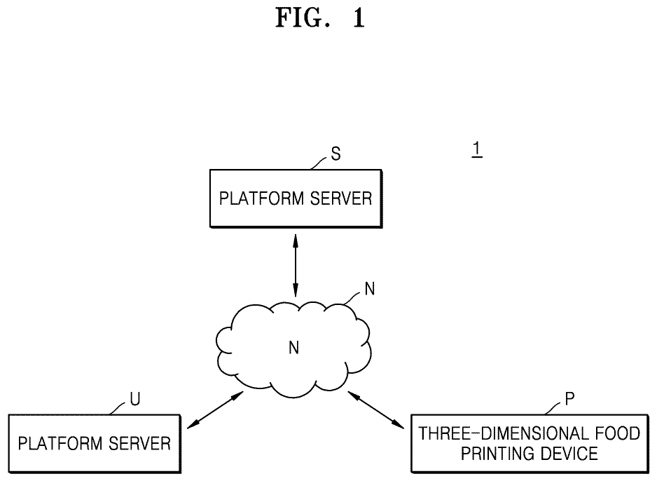

FIG. 1 is a schematic diagram illustrating a three-dimensional food printing system (hereinafter, “system”) according to an embodiment of the present disclosure.

Referring to FIG. 1, a system 1 includes a user terminal U, a platform server S, and a three-dimensional food printing device P.

The user terminal U refers to a user interface that receives input data related to three-dimensional food printing from a user. Here, although the input data may include a two-dimensional image and a type of a formulation including food ingredients, the present disclosure is not limited thereto, and the input data may further include identification information of the three-dimensional food printing device P (for example, a serial number). The user terminal U may be a mobile terminal such as a smartphone or tablet personal computer (PC), or a fixed terminal such as a PC, and any device that includes an input device capable of receiving a user input, such as a keyboard, a mouse, a touchscreen, a camera, a scanner, a code reader, or a microphone, may be used. The user terminal U may communicate with the platform server S through a solution such as an application or Internet webpage provided by the platform server S. Although one user terminal U is illustrated in FIG. 1, this is merely an example, and the number of user terminals U may be freely determined without departing from the essential spirit of the disclosure.

The platform server S refers to a computing device that provides an overall three-dimensional food printing service for printing three-dimensional food through the three-dimensional food printing device P. The platform server S may communicate with the three-dimensional food printing device P and the user terminal U through a network N. The platform server S may use a solution such as a dedicated application or Internet web page to communicate with the three-dimensional food printing device P and the user terminal U. The platform server S may generate a printing command that allows the three-dimensional food printing device P to print food based on input data input from the user terminal U. The specific operation of the platform server S will be described below.

The three-dimensional food printing device P is a device that three-dimensionally prints food based on food ingredients. The three-dimensional food printing device P may connect to and communicate with the platform server S through the network N. The three-dimensional food printing device P stores software or programs capable of reading data transmitted from the platform server S and controlling components based on the data. The three-dimensional food printing device P may include a print head (not shown) which extrudes a formulation consisting of a food ingredient paste and includes one or more nozzles, an ingredient cartridge (not shown) which is connected to the print head and stores a formulation used for printing, a build platform (not shown) which is a portion on which the formulation discharged from the print head is printed to form three-dimensional food, which has a flat and stable surface, and of which a temperature is controlled, a movement system (not shown) which moves the print head and/or the build platform along x-, y-, and z-axes and includes a sub-motor or a stepper motor, and a controller (not shown) which a computing system that controls each of the components included in the three-dimensional food printing device P described above and adjusts each of the components according to a printing command received from the platform server S.

The network N may include a local area network (LAN), a wide area network (WAN), a value-added network (VAN), a mobile radio communication network, a satellite communication network, and a combination thereof. In addition, the network N may be a comprehensive data communication network that enables respective components of the network N shown in FIG. 1 to smoothly communicate with each other, and may include wired Internet, wireless Internet, and mobile wireless communication networks. In addition, wireless communication may include, for example, wireless LAN (Wi-Fi), Bluetooth, Bluetooth Low Energy, Zigbee, Wi-Fi Direct (WFD), ultrawideband (UWB), infrared communication (infrared data association (IrDA)), near-field communication (NFC), or the like, but one or more embodiments are not limited thereto.

FIG. 2 is a flowchart illustrating a three-dimensional food printing method using the system 1 of FIG. 1.

The platform server S according to an embodiment of the present disclosure provides a single solution that performs the entire three-dimensional food printing process including modeling, slicing, and printing commands based on input data received from the user terminal U. Here, the solution refers to a dedicated application or an Internet web page.

In operation 110, the platform server S receives a two-dimensional image from a user. The two-dimensional image may be a flat image and may include a figure such as a circle, a quadrangle, a heart, or a star, as well as a line, a point, or a geometric shape.

In operation 120, the platform server S generates a three-dimensional image based on the input two-dimensional image and generates a modeling file. The three-dimensional may be a three-dimensional image and may include, for example, a sphere, a cone, a cylinder, a cube, a pyramid, a torus, a polyhedron, or the like. A process of generating the three-dimensional image from the two-dimensional image may be performed by using a known program, and thus a detailed description thereof is omitted.

In operation 130, the platform server S receives a type of a formulation including food ingredients from the user terminal U. In the present specification, the formulation may consist of various food ingredients and may refer to a material or ingredient used as food ink or edible ink in the three-dimensional food printing device P. For example, the formulation may include at least one selected from the group consisting of tempered chocolate, dough, a fruit and vegetable paste, a sugar paste, and a dairy product.

In operation 140, the platform server S determines output parameters corresponding to the type of the input formulation. Here, the output parameters may include at least one selected from the group consisting of a nozzle size (mm) indicating a nozzle or print head diameter, a nozzle or build platform temperature (° C.), a printing speed (mm/s) which is a speed at which a print head moves while extruding a formulation, and a flow (%) which is a parameter for controlling a speed and amount of the formulation extruded through a nozzle. However, the present disclosure is not limited thereto, and the output parameters may further include a height (mm) of one layer during three-dimensional food printing, a height (mm) of a first layer during three-dimensional food printing, an infill pattern which indicates a method or pattern for filling the interior during printing, an infill density (%) which is a parameter for determining how densely the interior is filled, a travel speed (mm/s) which is a speed when a print head moves without extruding a formulation, a retraction speed (mm/s) at which the formulation is retracted to stop a flow of the formulation to prevent the formation of droplets when the print head moves, a retraction distance (mm) which is a distance by which the formulation is retracted, and the like. A process by which the platform server S determines the output parameters corresponding to the type of the formulation, and optimal output parameters corresponding to each formulation will be described below.

In operation 150, the platform server S generates printing command data by performing slicing based on the determined output parameters and the generated three-dimensional modeling file. Here, the printing command data may be generated from the three-dimensional modeling file and may be written in a format of G-code which is a set of commands readable by a device, the G-code including at least one piece of information selected from the group consisting of a nozzle path which is a path along which the print head moves and in which a movement direction and position are designated by x, y, and z coordinates, a nozzle or build platform temperature (° C.), a printing speed (mm/s) which is a speed at which the print head moves while extruding a formulation, and a flow (%) which is a parameter for controlling a speed and amount of the formulation extruded through a nozzle. A method or system for generating the G-code are already known, and thus a detailed description thereof is omitted.

In operation 160, the platform server S transmits the printing command data to the three-dimensional food printing device P. The platform server S may transmit the printing command data to the three-dimensional food printing device P through the network N.

In operation 170, the three-dimensional food printing device P performs printing based on the printing command data. The printing command data may include the G-code, and since it is known that the three-dimensional food printing device P performs printing based on the G-code, a detailed description thereof is omitted.

Hereinafter, the three-dimensional food printing method described with reference to FIG. 2 will be described in detail based on a solution provided by the platform server S.

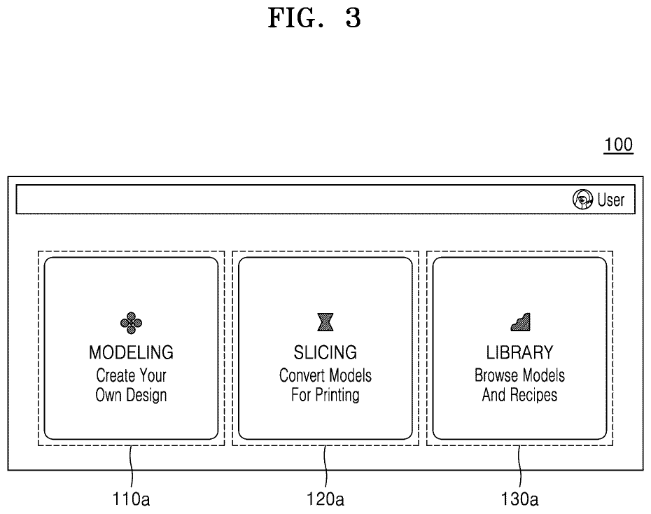

FIG. 3 illustrates an example of a home screen 100 of a solution according to an embodiment of the present disclosure.

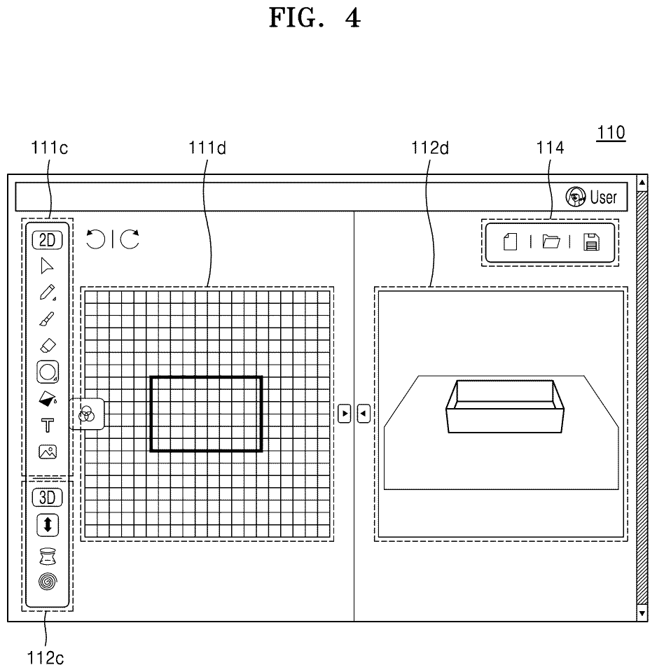

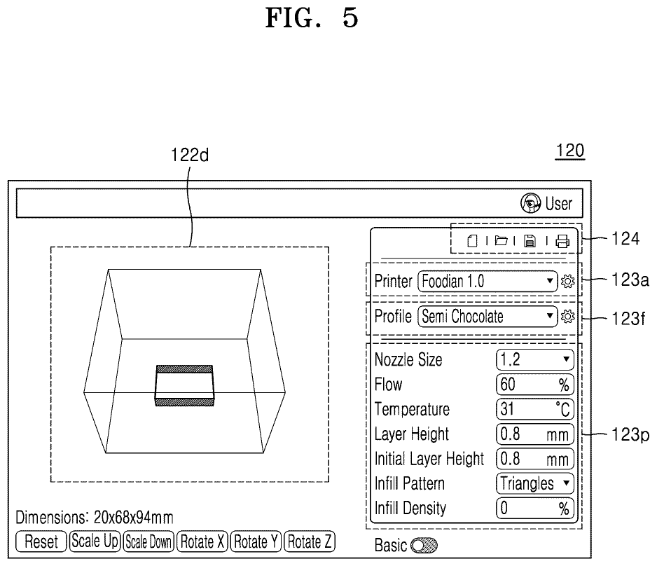

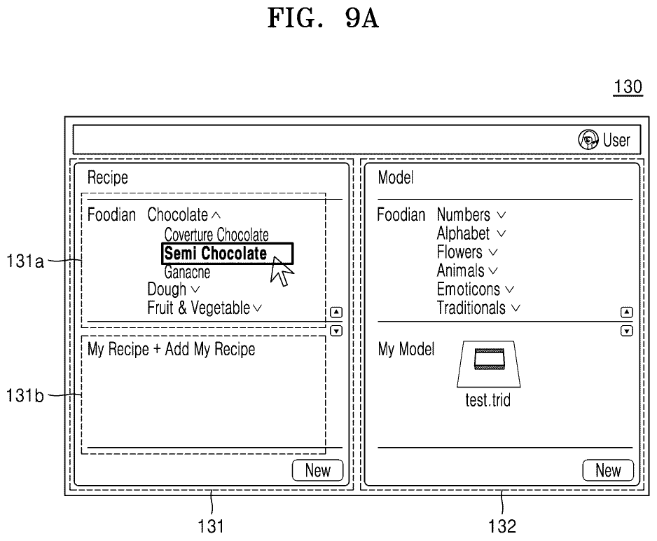

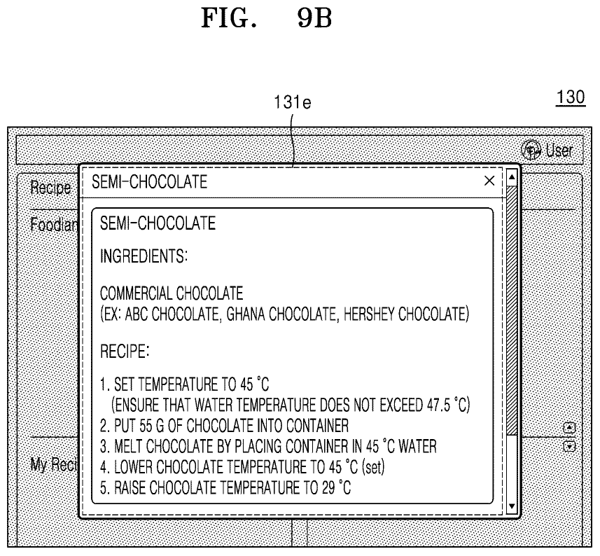

FIG. 3 illustrates the home screen 100 of the solution, and the home screen 100 may include a modeling button 110a, a slicing button 120a, and a library button 130a. When selected (tapped or clicked) by a user, the modeling button 110a guides a modeling screen 110 (see FIG. 4) that provides a function of receiving an input of a two-dimensional image from the user and generating and storing a three-dimensional modeling file. When selected (tapped or clicked) by a user, the slicing button 120a provides a slicing screen 120 (see FIG. 5) that provides a function of receiving printing conditions including a type of a formulation from the user, displaying determined output parameters, and allowing the user to modify the output parameters, and requests printing to the three-dimensional food printing device. When selected (tapped or clicked) by a user, the library button 130a displays a library screen 130 (see FIGS. 9A and 9B) that stores a three-dimensional modeling file generated by the user or previously stored, stores a type of a prestored formulation and a formula corresponding thereto, or displays a type of a formulation generated by the user or a combination and a ratio of food ingredients corresponding to the formulation.

In this way, the platform server S according to an embodiment of the present disclosure provides a single solution that performs the entire three-dimensional food printing process including modeling, slicing, and printing commands, thereby obtaining an effect of enabling one-stop three-dimensional food printing to improve user convenience.

FIG. 4 is an example of a modeling screen of a solution according to an embodiment of the present disclosure.

When the modeling button 110a is selected in FIG. 3, as shown in FIG. 4, a solution displays the modeling screen 110 that receives a two-dimensional image from a user. The modeling screen 110 may include a two-dimensional control panel 111c that allows a two-dimensional figure to be selected or directly drawn, a two-dimensional image display unit 111d that displays a two-dimensional image generated by the two-dimensional control panel, a three-dimensional image display unit 112d that displays a three-dimensional image generated based on an image displayed on the two-dimensional image display unit, a three-dimensional control panel 112c that allows a height of a three-dimensional image to be adjusted or modified, and a file control unit 114 that allows a three-dimensional image to be generated as a modeling file and stored in the user terminal U or the platform server S through a save button and allows the modeling file stored in the user terminal U or the platform to be retrieved through a load button.

The platform server S generates a two-dimensional image according to a user input on the two-dimensional control panel 111c and displays the generated two-dimensional image on the two-dimensional image display unit 111d. For example, in FIG. 4, a quadrangle has been selected, and the selected two-dimensional quadrangle has been displayed on the two-dimensional image display unit 111d. At the same time, the platform server S generates a three-dimensional image based on the generated two-dimensional image and displays the generated three-dimensional image on the three-dimensional image display unit 112d. For example, in FIG. 4, a quadrangular pillar with open upper and lower surfaces and a height corresponding to each side of the two-dimensional quadrangle is displayed on the three-dimensional image display unit 112d. Meanwhile, the platform server S generates and stores the generated three-dimensional image as a modeling file when a user selects a disk-shaped save button of the file control unit 114. The modeling file may be stored using an extension of a common three-dimensional (3D) model file format such as STL (Stereolithography), OBJ (Object), AMF (Additive Manufacturing File Format), 3MF (3D Manufacturing Format), PLY (Polygon File Format), or Foodian3D.

FIG. 5 is an example of the slicing screen 120 of a solution according to an embodiment of the present disclosure.

When the slicing button 120a is selected in FIG. 3, a solution provides a preview of a three-dimensional model and displays the slicing screen 120 that receives a type of a formulation. The slicing screen 120 may include a preview display unit 122d of a three-dimensional model that displays a three-dimensional image to be produced, a printer selection unit 123a that selects a type of the three-dimensional food printing device P, a formulation selection unit 123f that selects a type of a formulation, a parameter display unit 123p that displays output parameters determined according to the type of the selected formulation, and a file control unit 124 that, as compared to the file control unit 114 of FIG. 4, further includes a print execution button for transmitting a generated printing command to the selected three-dimensional food printing device P.

The platform server S may generate a printing command based on a three-dimensional image generated on the modeling screen 110 or a three-dimensional image prestored by a user. In addition, the platform server S displays, on the parameter display unit 123p, output parameters determined according to a type of the three-dimensional food printing device P input by a user through the printer selection unit 123a and/or a type of a formulation input through the formulation selection unit 123f, and allows the user to modify the output parameters as needed. Meanwhile, by using the print execution button, the platform server S transmits the generated printing command to the selected three-dimensional food printing device P through the network N.

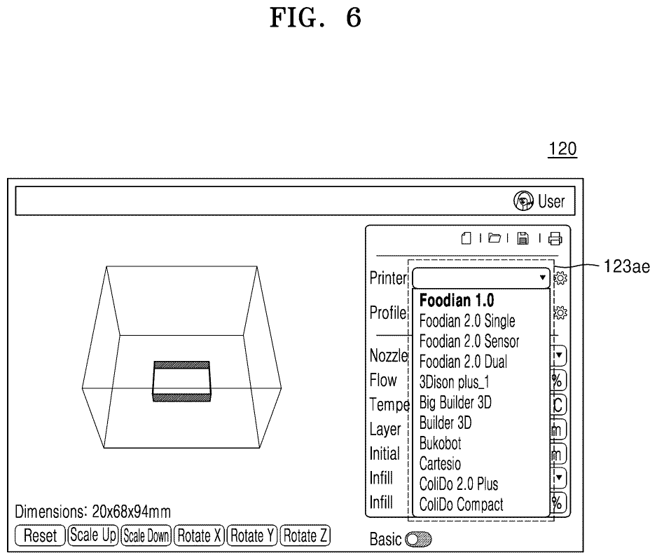

FIG. 6 is an example of a printer expansion list screen 120ae when the printer selection unit 123a is selected on the slicing screen 120 of FIG. 5.

When a drop-down arrow of the printer selection unit 123a is selected in FIG. 5, the printer expansion list screen 123ae in FIG. 6 is displayed. A list of the three-dimensional food printing devices P compatible with the solution according to the present embodiment may be displayed in a printer extension list.

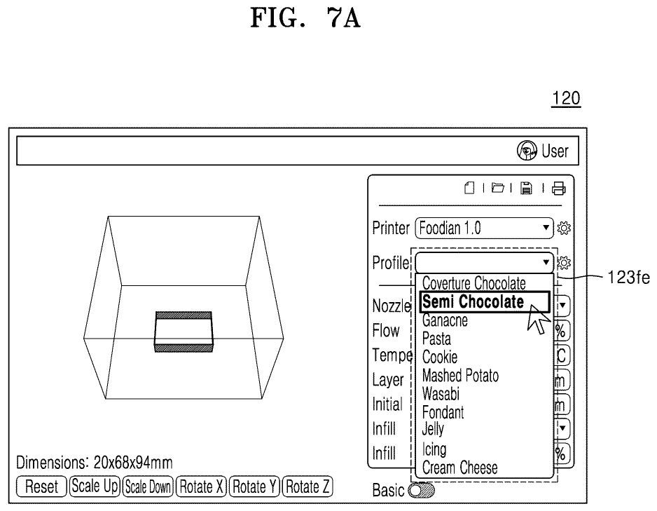

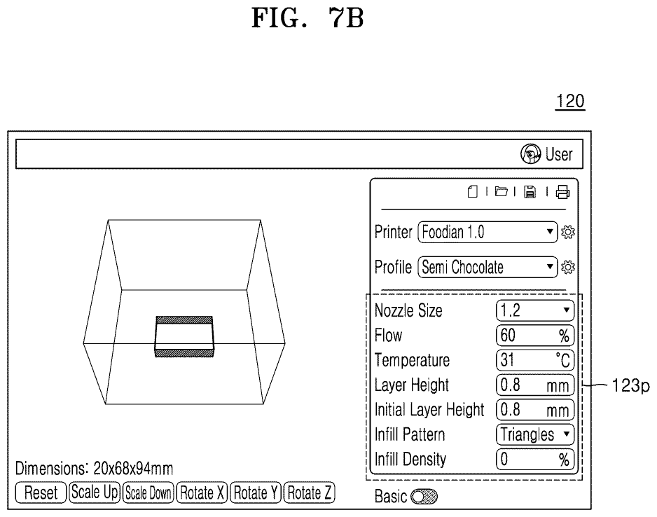

FIGS. 7A and 7B are examples of a formulation expansion list screen 123fe when the formulation selection unit 123f is selected on the slicing screen 120 of FIG. 5.

When a drop-down arrow of the formulation selection unit 123f is selected in FIG. 5, the formulation expansion list screen 123fe in FIGS. 7A and 7B are displayed. A plurality of formulations may be displayed in the formulation extension list. For example, the formulation may include at least one selected from the group consisting of tempered chocolate, dough, a fruit and vegetable paste, a sugar paste, and a dairy product. Specifically, the tempered chocolate may include a couverture chocolate formulation having a high cocoa butter content, a semi-chocolate (or a quasi-chocolate) formulation in which a cocoa solid and sugar are mixed and which is commercially available, and a ganache formulation in which chocolate and cream are mixed. The dough may include a pasta dough formulation, a cookie dough formulation, and the like. The fruit and vegetable pastes may include a mashed potato formulation, a wasabi formulation, and the like. The sugar paste may include a fondant formulation, a jelly formulation, an icing formulation, and the like. The dairy product may include a cream cheese formulation, a butter formulation, a butter cream formulation, and the like. However, the present disclosure is not limited to the above-described types of the formulations, and the formulations may be implemented with various food ingredients for three-dimensional food printing.

When one formulation is selected from the formulation expansion list as shown in FIG. 7A, optimal output parameters of the selected formulation are determined and displayed on the parameter display unit 123p as shown in FIG. 7B.

Meanwhile, a formulation is a viscous liquid or dough-like food ingredient, and in a process of extruding such a food ingredient to print three-dimensional food, resolution varies according to a nozzle size, an extrusion speed, and a nozzle movement speed, which makes it very difficult to set optimal printing conditions. In particular, in the case of food ingredients of which flowability changes significantly according to a temperature, a nozzle temperature is also an important printing condition. For example, according to a content of cocoa bean or a content of additives, chocolate may include various types in addition to couverture chocolate, semi-chocolate, and ganache. It is very difficult to set optimal printing conditions including a temperature, a nozzle size, an extrusion speed, and a flow, according to these various types of chocolates, and the optimal printing conditions are directly related to high-quality results and thus are very important. A system and method according to an embodiment of the present disclosure are characterized by providing optimal printing parameters for each of food ingredients, thereby obtaining high-quality results and enabling even beginners to obtain high-quality three-dimensional food printing results.

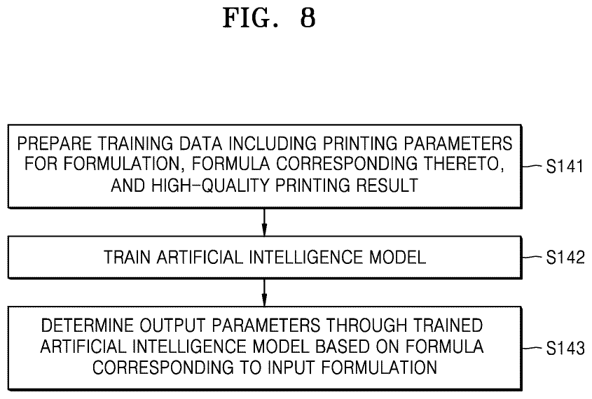

FIG. 8 is a flowchart illustrating an operation of determining output parameters of FIG. 2 according to an embodiment in detail.

Referring to FIG. 8, according to an embodiment, by using an artificial intelligence model trained through training data, the platform server S may determine output parameters based on a formula corresponding to a formulation.

In operation 141, the platform server S prepares training data for each formulation, wherein the training data includes printing parameters for a formula and a high-quality printing result which correspond to the formulation.

Here, the formula may include printing characteristic information, may include a type of a food ingredient used for preparing a formulation, a ratio of the food ingredient, a moisture content, a manufacturing temperature, and a manufacturing method, and may have a meaning similar to that of a recipe. Here, the printing characteristic information is information that affects printing parameters and refers to factors that include at least one of a type of a food ingredient, a ratio of a food ingredient (for example, a weight ratio), a manufacturing temperature, and a moisture content in the formula.

Here, the high-quality printing result refers to a printing result of which an evaluation value is greater than or equal to a certain reference value. Here, the evaluation value may be set based on at least one of resolution which indicates an ability to express details of a result, surface accuracy which indicates a degree of correspondence between a three-dimensional model and a result, surface quality which indicates the smoothness and texture of a result surface, structural integrity which indicates the physical strength and durability of a result, taste and texture, ingredient efficiency, printing speed which is a speed until a result is completed, and consistency which indicates a comparison between degrees to which results are consistently produced when printing is repeated under the same settings.

Here, the printing parameters may include at least one selected from the group consisting of a nozzle size (mm) indicating a nozzle or print head diameter, a nozzle or build platform temperature (° C.), a printing speed (mm/s) which is a speed at which a print head moves while extruding a formulation, and a flow (%) which is a parameter for controlling a speed and amount at which the formulation is extruded through a nozzle. However, the present disclosure is not limited thereto, and the printing parameters may further include a height (mm) of one layer during three-dimensional food printing, a height (mm) of a first layer during three-dimensional food printing, an infill pattern which indicates a method or pattern for filling the inside during printing, an infill density (%) which is a parameter that determines how densely the inside is filled, a travel speed (mm/s) which is a speed at which a print head moves without extruding a formulation, a retraction speed (mm/s) at which the formulation is retracted to stop a flow of the formulation to prevent the formation of bubbles when the print head moves, a retraction distance (mm) which is a distance by which the formulation is retracted, and the like.

In an embodiment, the training data may be a tabular dataset for each formulation, which includes, in a plurality of columns, data related to printing characteristic information of a formula and printing parameters. In addition, a plurality of pieces of training data may be prepared for each formulation. However, the present disclosure is not limited thereto, and the training data may further include, for each formulation, columns including one or more pieces of printing characteristic information selected from the group consisting of viscosity, setting time, flowability, elasticity, thermal conductivity, which indicates an ability to transfer heat, and adhesion, which indicates how well a formulation is attached to a build platform or a previous layer.

In operation 142, the platform server S trains the artificial intelligence model through the training data. For example, an artificial intelligence-based analysis model may be an algorithm based on a deep learning model, but is not limited thereto. It goes without saying that an analysis model disclosed herein may be applied to various artificial intelligence-based algorithms that are already known or may be developed in the future.

In operation 143, when a specific formulation is input to the slicing screen 120 by a user in operation 130, the platform server S extracts, from a library, a formula corresponding to the input formulation, and determines output parameters through the trained artificial intelligence model based on printing characteristic information included in the extracted formula.

In an embodiment, the platform server S performs training based on a formula (recipe) of a formulation and determines output parameters based on the training. Accordingly, in determining the output parameters, even without separate measurement-required information such as viscosity, setting time, flowability, elasticity, thermal conductivity, or adhesion of the formulation, the platform server may determine the output parameters by using at least one of a type of a food ingredient, a ratio of the food ingredient, a manufacturing temperature, and a moisture content, which is printing characteristic information included in the formula. That is, according to the present disclosure, even beginners may determine optimal output parameters even without professional measurement data about a formulation. As a result, according to the present disclosure, there is an effect of enabling even beginners to obtain high-quality three-dimensional food printing results.

An embodiment related to a method of determining the output parameters through the artificial intelligence model has been described with reference to FIG. 8, but the present disclosure is not limited thereto. In another embodiment, the output parameters may be determined by user selection. For example, a user may determine output parameters optimized through experience in response to a formulation and store the determined output parameters in the platform server S. In addition, the user may retrieve corresponding output parameters from the slicing screen 120 according to the selection of the formulation and use the retrieved output parameters for three-dimensional food printing.

FIGS. 9A and 9B are examples of the library screen 130 of a solution according to an embodiment of the present disclosure.

Referring to FIGS. 9A and 9B, the library screen 130 includes a formula display unit 131 that displays content related to a formula at a left side, and a modeling display unit 132 that displays content related to modeling at a right side. As shown in FIG. 9A, when one formulation of a prestored formulation list is selected from an upper portion 131a of the formula display unit, a formula corresponding to the formulation may be checked in a pop-up window as shown in FIG. 9A. In addition, as shown in FIG. 9A, on a lower portion 131b of the formula display unit, the user may also add a formula developed by the user to a library. In this case, the formula should necessarily include printing characteristic information including a type of a food ingredient, a ratio of the food ingredient (for example, a weight ratio), a manufacturing temperature, or the like, and as described with reference to FIG. 8, output parameters may be determined through an artificial intelligence model trained based on the printing characteristic information.

Hereinafter, embodiments of formulas for various formulations will be described, and optimal output parameters for a formulation determined based on a corresponding formula will also be described.

Here, the formulation may include chocolates such as couverture chocolate, semi-chocolate, and ganache, doughs such as pasta dough and cookie dough, fruit and vegetable pastes such as mashed potato and wasabi, sugar pastes such as fondant, jelly, and icing, and dairy products such as cream cheese, butter, and buttercream, but the present disclosure is not limited thereto. The formulation may further include various formulations or food inks.

According to an embodiment of the present disclosure, the output parameters of the formulation include a nozzle size indicating a diameter of about 0.5 mm to 1.5 mm (advantageously a diameter of about 0.8 mm to 1.2 mm), a flow of about 45% to 75% (advantageously about 50% to 70%), a nozzle temperature of about 23° C. to 42° C. (advantageously about 25° C. to 40° C.), and a printing speed of about 15 mm/s to 35 mm/s (advantageously about 20 mm/s to 30 mm/s).

Here, when a nozzle diameter is less than 0.5 mm, it is difficult for a formulation to be discharged from a nozzle, and when the nozzle diameter exceeds 1.5 mm, it is difficult for the discharged formulation to form a desired three-dimensional shape.

Here, when the flow is less than 45%, an amount and speed of an ingredient output through a printer head are small, which causes a problem in that a lot of empty space is formed in a three-dimensional shape, and when the flow exceeds 75%, an excessive amount of an ingredient is output, which causes a problem in that the three-dimensional shape collapses.

Here, when the nozzle temperature is less than 23° C., the flowability of an ingredient is not secured, resulting in a difficulty in controlling a discharge speed, and the ingredient is not uniformly discharged, resulting in a degradation in layer consistency, and an interlayer force is weak, resulting in a problem of degradation in three-dimensional structural integrity. When the nozzle temperature exceeds 42° C., the flowability of the ingredient is excessively increased, which makes it difficult to control the flowability, makes it difficult to maintain a desired three-dimensional shape, and causes a problem in that the ingredient deteriorates.

Here, when the printing speed is less than 15 mm/s, an ingredient is exposed to heat inside a nozzle for a long time, which causes an ingredient to deteriorate, and a new layer is stacked in a state in which a previous layer has already been cured, which weakens an interlayer bonding force and produces a structurally weak result. When the printing speed exceeds 35 mm/s, a printer head may not place an ingredient at a correct position, and there may be a problem in that the surface quality and extrusion of the ingredient are non-uniform.

Hereinafter, specific and detailed embodiments of optimal output parameters for each formulation will be described.

### <Chocolate Formulation and Optimal Output Parameters>

Hereinafter, a chocolate formulation and an optimal output parameters will be described with reference to Table 1.

TABLE 1

| Formulation/output | | | |
|---|---|---|---|
| parameters | Couverture chocolate | Semi-chocolate | Ganache |
| Nozzle size | First nozzle size (diameter | First nozzle size (diameter | First nozzle size (diameter |
| | of about 1.0 to 1.4 mm) | of about 1.0 to 1.4 mm) | of about 1.0 to 1.4 mm) |
| Flow | First flow (about 55% to | First flow (about 55% to | Second flow (about 45% |
| | 65%) | 65%) | to 54%) |
| Nozzle temperature | Second temperature | Third temperature (about | Fourth temperature |
| | (about 26.5° C. to 27.5° | 30.5° C. to 32° C.) | (about 25.5° C. to 26.4° |
| | C.) | | C.) |
| Printing speed | First printing speed (about | First printing speed (about | First printing speed (about |
| | 25 mm/s to 35 mm/s) | 25 mm/s to 35 mm/s) | 25 mm/s to 35 mm/s) |

In an embodiment, the chocolate formulation includes a couverture chocolate formulation, and the couverture chocolate formulation consists of tempered couverture chocolate in a first temperature range (or at a first temperature). In addition, in this case, among output parameters, a nozzle temperature may be determined as a second temperature lower than the first temperature range, a nozzle size may be determined as a first nozzle size, a flow may be determined as a first flow, and a printing speed may be determined as a first printing speed.

Specifically, in an embodiment, the couverture chocolate formulation includes dark chocolate, milk chocolate, and/or white couverture chocolate as a single ingredient and corresponds to a formulation in which a temperature of boiling water, in which couverture chocolate (for example, about 55 g) is to be heated, is set to about 45° C., and a temperature of the couverture chocolate is raised to about 45° C., then lowered to about 27° C., and subsequently raised again to the first temperature range of about 29° C. to 32° C. In this case, the output parameters may include a nozzle size indicating a diameter of about 1.0 to 1.4 mm (preferably a diameter of about 1.2 mm) which is the first nozzle size, a flow of about 55% to 65% (preferably about 60%), a nozzle temperature of about 26.5° C. to 27.5° C. (preferably about 27° C.) which is the second temperature lower than the first temperature range, and a printing speed of about 25 mm/s to 35 mm/s (preferably about 30 mm/s) which is the first printing speed.

Here, the nozzle temperature is the second temperature lower than the first temperature range. When the nozzle temperature exceeds the maximum value of the second temperature, the flowability of the couverture chocolate is too high, which makes it difficult to obtain a desired shape, and when the nozzle temperature is lower than the minimum value of the second temperature, there is a problem in that the couverture chocolate is not properly discharged through a nozzle. In addition, when the flow is less than the minimum value of the first flow, an amount and speed of an ingredient output through a nozzle are small, which causes a problem in that a lot of empty space is formed in a three-dimensional shape, and when the flow exceeds the maximum value of the first flow, an excessive amount of the ingredient is output, which causes a problem in that the three-dimensional shape collapses. At a corresponding nozzle temperature and flow, when the nozzle size is less than the minimum value of the first nozzle size, it is difficult to discharge an ingredient, and when the nozzle size exceeds the maximum value of the first nozzle size, an excessive amount of the ingredient is discharged, which makes it difficult to obtain a uniform result. In addition, when the printing speed is less than the minimum value of the first printing speed at a corresponding nozzle temperature, a new layer is stacked in a state in which a previous layer has already been cured, which weakens an interlayer bonding force and produces a structurally weak result. In addition, when the printing speed exceeds the maximum value of the first printing speed, a printer head may not place an ingredient at a correct position, and there may be a problem in that the surface quality and extrusion of the ingredient are non-uniform.

In another embodiment, the chocolate formulation includes a semi-chocolate formulation, and the semi-chocolate formulation consists of tempered semi-chocolate in the first temperature range. In addition, in this case, among the output parameters, the nozzle temperature may be determined as a third temperature that belongs to the first temperature range and is higher than the second temperature, the nozzle size may be determined as a second nozzle size that is smaller than the first nozzle size, the flow may be determined as the first flow, and the printing speed may be determined as the first printing speed.

Specifically, in an embodiment, the semi-chocolate formulation includes commercially available semi-chocolate as a single ingredient and corresponds to a formula in which a temperature of boiling water, in which semi-chocolate (for example, about 55 g) is to be heated, is set to about 45° C., and a temperature of the semi-chocolate is raised to about 45° C., then lowered to about 27° C., and subsequently raised again to the first temperature range of about 29° C. to 32° C. In this case, the output parameters may include a nozzle size indicating a diameter of about 1.0 to 1.4 mm (preferably a diameter of about 1.2 mm) which is the first nozzle size, a flow of about 55% to 65% (preferably about 60%) which is the first flow, a nozzle temperature of about 30.5° C. to 32° C. (preferably about 31° C.) which is the third temperature that belongs to the first temperature range but is higher than the second temperature, and a printing speed of about 25 mm/s to 35 mm/s (preferably about 30 mm/s) which is the first printing speed.

Here, there is a problem in that when the nozzle size is less than the minimum value of the first nozzle size, it is difficult to discharge an ingredient, and when the nozzle size exceeds the maximum value of the first nozzle size, it is difficult to control a result. Meanwhile, due to a cocoa powder, sugar, and additives included in the semi-chocolate, only when the nozzle temperature should be maintained at the third temperature higher than the second temperature as compared to couverture chocolate, a shape of a result does not collapse, and uniform ingredient discharge is possible. In addition, when the flow is less than the minimum value of the first flow, an amount and speed of an ingredient output through a nozzle are small, which causes a problem in that a lot of empty space is formed in a three-dimensional shape, and when the flow exceeds the maximum value of the first flow, an excessive amount of the ingredient is output, which causes a problem in that the three-dimensional shape collapses. In addition, when the printing speed is less than the minimum value of the first printing speed at a corresponding nozzle temperature, a new layer is stacked in a state in which a previous layer has already been cured, which weakens an interlayer bonding force and produces a structurally weak result. In addition, when the printing speed exceeds the maximum value of the first printing speed, a printer head may not place an ingredient at a correct position, and there may be a problem in that the surface quality and extrusion of the ingredient are non-uniform.

In another embodiment, the chocolate formulation includes a ganache formulation, and the ganache formulation consists of dark chocolate and fresh cream in a weight ratio of 2:1. In this case, among the output parameters, the nozzle temperature may be determined as the second temperature lower than the first temperature, the nozzle size may be determined as the first nozzle size, the flow may be determined as a second flow lower than the first flow, and the printing speed may be determined as the first printing speed.

Specifically, in an embodiment, the ganache formulation includes, as ingredients, dark chocolate (for example, about 100 g) and fresh cream (for example, about 50 g) in a weight ratio of 2:1 and corresponds to a formula in which the dark chocolate is heated in boiling water to a temperature of about 50° C., the fresh cream is heated to a temperature of about 80° C., and then the fresh cream at a temperature of about 80° C. is gradually poured into the melted dark chocolate and stirred. In this case, the output parameters include a nozzle size indicating a diameter of about 1.0 to 1.4 mm (preferably a diameter of about 1.2 mm) which is the first nozzle size, a flow of about 45% to 54% (preferably about 50%) which is the second flow lower than the first flow, a nozzle temperature of about 25.5° C. to 26.4° C. (preferably about 26° C.) which is a fourth temperature lower than the second temperature, and a printing speed of about 25 mm/s to 35 mm/s (preferably about 30 mm/s) which is the first printing speed.

Here, the nozzle temperature of the ganache formulation is lower than that of the couverture chocolate formulation and the semi-chocolate formulation, and the flow thereof also is the second flow lower than the first flow that is a flow of the couverture chocolate formulation and the semi-chocolate formulation. This is because flowability is secured by fresh cream included in ganache. In numerical ranges other than the fourth temperature and second flow, it is difficult to produce uniform results due to excessive or insufficient flowability. Meanwhile, there is a problem in that when the nozzle size is less than the minimum value of the first nozzle size at the nozzle temperature of the fourth temperature and the second flow for the ganache formulation, it is difficult to discharge an ingredient, and when the nozzle size exceeds the maximum value of the first nozzle size, it is difficult to control a result. In addition, when the printing speed is less than the minimum value of the first printing speed at a corresponding nozzle temperature, a new layer is stacked in a state in which a previous layer has already been cured, which weakens an interlayer bonding force and produces a structurally weak result. In addition, when the printing speed exceeds the maximum value of the first printing speed, a printer head may not place an ingredient at a correct position, and there may be a problem in that the surface quality and extrusion of the ingredient are non-uniform.

### <Dough Formulation and Optimal Output Parameters>

Hereinafter, a dough formulation and optimal output parameters will be described with reference to Table 2.

TABLE 2

| Formulation/output | | |
|---|---|---|
| parameters | Pasta dough | Cookie dough |
| Nozzle size | First nozzle size (diameter of about 1.0 | First nozzle size (diameter of about 1.0 |
| | to 1.4 mm) | to 1.4 mm) |
| Flow | First flow (about 55% to 65%) | First flow (about 55% to 65%) |
| Nozzle | Fifth temperature (about 39° C. to 41° | Sixth temperature (about 24.5° C. to |
| temperature | C.) | 25.4° C.) |
| Printing speed | Second printing speed (about 15 mm/s | First printing speed (about 25 mm/s to |
| | to 24 mm/s) | 35 mm/s) |

In an embodiment, the dough formulation includes a pasta dough formulation, and the pasta dough formulation consists of durum wheat flour, rice flour, and an egg in a weight ratio of 6:9:10. In this case, among output parameters, a nozzle size may be determined as a first nozzle size, a flow may be determined as a first flow, and a printing speed may be determined as a second printing speed that is less (slower) than a first printing speed.

Specifically, in an embodiment, the pasta dough formulation includes, as ingredients, durum wheat flour (for example, about 60 g), rice flour (for example, about 90 g), and an egg (for example, about 100 g) in a weight ratio of 6:9:10 and corresponds to a formula in which the durum wheat flour and rice flour are sieved and then mixed with the egg to knead dough. In this case, the output parameters include a nozzle size indicating a diameter of about 1.0 to 1.4 mm (preferably a diameter of about 1.2 mm) which is the first nozzle size, a flow of about 55% to 65% (preferably about 60%) which is the first flow, a nozzle temperature of about 49° C. to 41° C. (preferably about 40° C.) which is a fifth temperature, and a printing speed of about 15 mm/s to 24 mm/s (preferably about 20 mm/s) which is the second printing speed that is less (lower) than the first printing speed.

Here, when the nozzle temperature is the fifth temperature, the nozzle temperature is an optimal temperature at which water molecules in the dough move actively to allow starch and protein to be hydrated, and is an optimal temperature at which starch in a rice powder gelatinizes to increase the viscosity of the dough and secure flowability. When the nozzle temperature is less or more than the fifth temperature range, hydration and gelatinization are not sufficient, which makes it difficult to secure flowability of an ingredient. In addition, it is preferable that the printing speed is lower than that of chocolate and is the second printing speed that is optimized for dough. When the printing speed is lower or more than a second printing speed range, it is difficult to obtain uniform quality results from corresponding dough. The nozzle size and flow are a nozzle size and flow optimized for the nozzle temperature of the fifth temperature and the second printing speed, and when the nozzle size and flow are less or more than a corresponding numerical range, it is difficult to obtain uniform quality results.

In another embodiment, the dough formulation includes a cookie dough formulation, and the cookie dough formulation consists of cake flour, butter, sugar, an egg, and a baking powder in a weight ratio of 100:90:60:15:1. In this case, among the output parameters, the nozzle size may be determined as the first nozzle size, the flow may be determined as the first flow, and the printing speed may be determined as the first printing speed.

Specifically, in an embodiment, the cookie dough formulation includes, as ingredients, cake flour (for example, about 200 g), butter (for example, about 180 g), sugar (for example, about 120 g), an egg (for example, about 30 g), and a baking powder (for example, about 2 g) in a weight ratio of 100:90:60:15:1. The cookie dough formulation corresponds to a formula configured as follows. After portions of the butter and the sugar are whipped and creamed, the egg is added and creamed. Next the cake flour and the baking powder are mixed and sifted, and then a result is rested in a refrigerator for about 30 minutes. In this case, the output parameters include a nozzle size indicating a diameter of about 1.0 to 1.4 mm (preferably a diameter of about 1.2 mm) which is the first nozzle size, a flow of about 55% to 65% (preferably about 60%) which is the first flow, a nozzle temperature of about 24.5° C. to 25.4° C. (preferably about 25° C.) which is a sixth temperature lower than first to fifth temperatures, and a printing speed of about 25 mm/s to 35 mm/s (preferably about 30 mm/s) which is the first printing speed.

Here, there is a problem in that when the nozzle temperature is less or more than a sixth temperature range, the baking powder, which is a chemical leavening agent, may be impeded from initially reacting by moisture, which makes it impossible to manufacture a uniform final result. In addition, when the nozzle size is less than a first nozzle size range, a dough ingredient blocks a discharge port, and when the nozzle size exceeds the first nozzle size range, the dough ingredient is discharged excessively, which makes it difficult to control a shape. When the flow is less than a first flow range, an amount and speed of an ingredient outputted through a nozzle are small, which causes a problem in that a lot of empty space is formed in a three-dimensional shape, and when the flow exceeds the first flow range, an excessive amount of the ingredient is output, which causes a problem in that the three-dimensional shape collapses. In addition, when the printing speed is less than a first printing speed range at a corresponding nozzle temperature, a new layer is stacked in a state in which a previous layer has already been cured, which weakens an interlayer bonding force and produces a structurally weak result. In addition, when the printing speed exceeds the first printing speed range, a printer head may not place an ingredient at a correct position, and there may be a problem in that the surface quality and extrusion of the ingredient are non-uniform.

### <Fruit and Vegetable Paste Formulation and Optimal Output Parameters>

Hereinafter, a fruit and vegetable paste formulation and optimal output parameters will be described with reference to Table 3.

TABLE 3

| Formulation/output | | |
|---|---|---|
| parameters | Mashed potato | Wasabi |
| Nozzle size | First nozzle size (diameter of about | First nozzle size (diameter of about |
| | 1.0 to 1.4 mm) | 1.0 to 1.4 mm) |
| Flow | First flow (about 55% to 65%) | First flow (about 55% to 65%) |
| Nozzle | Seventh temperature (about 29° C. | Sixth temperature (about 24.5° C. to |
| temperature | to 30.4° C.) | 25.4° C.) |
| Printing speed | First printing speed (about 25 mm/s | First printing speed (about 25 mm/s |
| | to 35 mm/s) | to 35 mm/s) |

In an embodiment, the fruit and vegetable paste includes a mashed potato formulation, and the mashed potato formulation consists of a potato powder and water in a weight ratio of 2:7. In this case, among output parameters, a nozzle size may be determined as a first nozzle size, a flow may be determined as a first flow, and a printing speed may be determined as a first printing speed.

Specifically, the mashed potato formulation according to an embodiment includes, as ingredients, a mashed potato powder (for example, 100 g) and water or milk (for example, 350 ml) in a weight ratio of 2:7 and corresponds to a formula in which the mashed potato powder and water (or milk) are mixed. In this case, the output parameters include a nozzle size indicating a diameter of about 1.0 to 1.4 mm (preferably a diameter of about 1.2 mm) which is the first nozzle size, a flow of about 55% to 65% (preferably about 60%) which is the first flow, a nozzle temperature of about 29° C. to 30.4° C. (preferably about 30° C.) which is a seventh temperature, and a printing speed of about 25 mm/s to 35 mm/s (preferably about 30 mm/s) which is the first printing speed.

Here, when the nozzle temperature is less or more than a seventh temperature range, the hydration of potato starch in mashed potato may be hindered, which may adversely affect flowability and cause a problem in that it is impossible to manufacture a uniform final result. In addition, when the nozzle size is less than a first nozzle size range, a dough ingredient blocks a discharge port, and when the nozzle size exceeds the first nozzle size range, the dough ingredient is discharged excessively, which makes it difficult to control a shape. When the flow is less than a first flow range, an amount and speed of an ingredient outputted through a nozzle are small, which causes a problem in that a lot of empty space is formed in a three-dimensional shape, and when the flow exceeds the first flow range, a large amount of the ingredient is output, which causes a problem in that the three-dimensional shape collapses. In addition, when the printing speed is less than the first printing speed at a corresponding nozzle temperature, a new layer is stacked in a state in which a previous layer has already been cured, which weakens an interlayer bonding force and produces a structurally weak result. In addition, when the printing speed exceeds the first printing speed range, a printer head may not place an ingredient at a correct position, and there may be a problem in that the surface quality and extrusion of the ingredient are non-uniform.

In another embodiment, the fruit and vegetable paste includes a wasabi formulation, and the wasabi formulation consists of a wasabi powder and water in a weight ratio of 2:3. In this case, among the output parameters, the nozzle size may be determined as the first nozzle size, the flow may be determined as the first flow, and the printing speed may be determined as the first printing speed.

Specifically, the wasabi formulation according to an embodiment includes, as ingredients, a wasabi powder (for example, about 200 g) and water (for example, about 300 ml) in a weight ratio of 2:3, and corresponds to a formula in which the wasabi powder is sieved and then mixed with water. In this case, the output parameters include a nozzle size indicating a diameter of about 1.0 to 1.4 mm (preferably a diameter of about 1.2 mm) which is the first nozzle size, a flow of about 55% to 65% (preferably about 60%) which is the first flow, a nozzle temperature of about 24.5° C. to 25.4° C. (preferably about 25° C.) which is a sixth temperature, and a printing speed of about 25 mm/s to 35 mm/s (preferably about 30 mm/s) which is the first printing speed.

Here, when the nozzle temperature is less or more than a sixth temperature range, the hydration of a horseradish powder and starch contained in the wasabi powder may be hindered, which may adversely affect flowability and cause a problem in that it is impossible to manufacture a uniform final result. Numerical ranges of the nozzle size, the flow, and the printing speed have the same critical significance as the above-described mashed potato formulation, and thus a redundant description thereof will be omitted.

### <Sugar Paste Formulation and Optimal Output Parameters>

Hereinafter, a sugar paste formulation and optimal output parameters will be described with reference to Table 4.

TABLE 4

| Formulation/output | | | |
|---|---|---|---|
| parameters | Fondant | jelly | Icing |
| Nozzle size | First nozzle size | First nozzle size | First nozzle size |
| | (diameter of about 1.0 to | (diameter of about 1.0 to | (diameter of about 1.0 to |
| | 1.4 mm) | 1.4 mm) | 1.4 mm) |
| Flow | First flow (about 55% to | Third flow (about 66% to | First flow (about 55% to |
| | 65%) | 75%) | 65%) |
| Nozzle | Sixth temperature (about | Eighth temperature | Sixth temperature (about |
| temperature | 24.5° C. to 25.4° C.) | (about 34° C. to 36° C.) | 24.5° C. to 25.4° C.) |
| Printing speed | First printing speed | First printing speed | First printing speed |
| | (about 25 mm/s to 35 | (about 25 mm/s to 35 | (about 25 mm/s to 35 |
| | mm/s) | mm/s) | mm/s) |

In an embodiment, the sugar paste formulation includes a fondant formulation, and the fondant formulation includes a sugar powder, water, powdered gelatin, corn syrup, shortening (or butter), and egg white in a weight ratio of 300:20:5:35:3:10. In this case, among output parameters, a nozzle size may be determined as a first nozzle size, a flow may be determined as a first flow, and a printing speed may be determined as a first printing speed.

Specifically, in an embodiment, in addition to a sugar powder (for example, about 300 g), water (for example, about 20 g), powdered gelatin (for example, about 5 g), corn syrup (for example, about 35 g), shortening (or butter) (for example, about 3 g), and egg white (for example, about 10 g) in a weight ratio of 300:20:5:35:3:10, the fondant formulation further includes about 2 to 3 drops of lemon juice (about 0.1 g to 0.3 g) as an ingredient, and corresponds to a formula configured as follows. A sifted sugar power is prepared on a kneading mat, and the lemon juice is added to the egg white and prepared. The shortening (or butter) is added to the syrup and heated in a microwave (about 500 W) for about 30 seconds. Next, water and the powdered gelatin are mixed well and heated in the microwave (about 500 W) for about 45 seconds. The center of the sifted sugar powder is concavely recessed, and liquids (the egg white to which the lemon juice is added, the corn syrup to which the shortening (or butter) is added, and water to which the powdered gelatin is added) are put into the recessed center. The sugar powder is divided and mixed with a scraper and then finished by hand kneading. In this case, the output parameters include a nozzle size indicating a diameter of about 1.0 to 1.4 mm (preferably a diameter of about 1.2 mm) which is the first nozzle size, a flow of about 55% to 65% (preferably about 60%) which is the first flow, a nozzle temperature of about 24.5° C. to 25.4° C. (preferably about 25° C.) which is a sixth temperature, and a printing speed of about 25 mm/s to 35 mm/s (preferably about 30 mm/s) which is the first printing speed.

Here, there is a problem in that when the nozzle temperature is less than the lower limit of a sixth temperature range, gelatin solidifies, and thus an ingredient is not properly discharged through a nozzle, and when the nozzle temperature exceeds the sixth temperature range, excessive flowability is added to the ingredient, and thus a uniform result is not manufactured. When the nozzle size is less than a first nozzle size range, a fondant ingredient blocks a discharge port, and when the nozzle size exceeds the first nozzle size range, the fondant ingredient is discharged excessively, which makes it difficult to control a shape. When the flow is less than a first flow range, an amount and speed of an ingredient outputted through a nozzle are small, which causes a problem in that a lot of empty space is formed in a three-dimensional shape, and when the flow exceeds the first flow range, an excessive amount of the ingredient is output, which causes a problem in that the three-dimensional shape collapses. In addition, when the printing speed is less than a first printing speed range, a new layer is stacked in a state in which a previous layer has already been cured, which weakens an interlayer bonding force and produces a structurally weak result. In addition, when the printing speed exceeds the first printing speed range, fondant, which is an ingredient including sugar, generally has low viscosity, which makes it difficult to control a fast printing speed and causes a problem in that a large amount of air is trapped in a result.

In another embodiment, the sugar paste formulation includes a jelly (or Jell-O) formulation, and the jelly formulation consists of gelatin, pectin, water, sugar, and lemon juice in a weight ratio of 10:8:51:30:1. In this case, among the output parameters, the nozzle size may be determined as the first nozzle size, the flow may be determined as a third flow greater than the first flow, and the printing speed may be determined as the first printing speed.

Specifically, in an embodiment, the jelly formulation includes, as ingredients, gelatin (for example, 10 g), pectin (for example, 8 g), water (for example, 51 g), sugar (for example, 30 g), and lemon juice (for example, 1 g) in a weight ratio of 10:8:51:30:1, and corresponds to a formula in which after the gelatin is soaked in cold water, the soaked gelatin, water, the pectin, the sugar, and the lemon juice are added, boiled over medium heat, and then cooled. In this case, the output parameters include a nozzle size indicating a diameter of about 1.0 to 1.4 mm (preferably a diameter of about 1.2 mm) which is the first nozzle size, a flow of about 66% to 75% (preferably about 70%) which is the third flow, a nozzle temperature of about 34° C. to 36° C. (preferably about 35° C.) which is an eighth temperature, and a printing speed of about 25 mm/s to 35 mm/s (preferably about 30 mm/s) which is the first printing speed.

Here, there may be a problem in that when the nozzle temperature is less than an eighth temperature range, the gelatin may be coagulated, and thus an ingredient may not be properly discharged through a nozzle, and when the nozzle temperature exceeds the eighth temperature range, the gelatin may be destroyed, and thus the ingredient is deteriorated. Meanwhile, there is a problem in that when the flow is less or more than a third flow range, the flow is not suitable for the viscosity or flowability of the gelatin, and thus a non-uniform result is manufactured. In addition, there is a problem in that when the nozzle size is less than a first nozzle size range at a corresponding flow, an ingredient is not discharged, and when the nozzle size exceeds the first nozzle size range, the jelly is discharged excessively, which makes it difficult to manufacture a three-dimensional shape. Meanwhile, when the printing speed is less than the minimum value of the first printing speed range at a corresponding nozzle temperature, flow, and nozzle size, a new layer is stacked in a state in which a previous layer has already been cured, which weakens an interlayer bonding force and produces a structurally weak result. When the printing speed exceeds the maximum value of the first printing speed range, the jelly flows down without being stacked, which causes a problem in that surface quality is degraded and extrusion is non-uniform.

In another embodiment, the sugar paste formulation includes an icing formulation, and the icing formulation consists of a sugar powder, egg white, and lemon juice in a weight ratio of 80:20:1. In this case, among the output parameters, the nozzle size may be determined as the first nozzle size, the flow may be determined as the first flow, and the printing speed may be determined as the first printing speed.

Specifically, in an embodiment, the icing formulation includes, as ingredients, a sugar powder (for example, about 160 g), egg white (for example, about 40 g), and lemon juice (for example, about 2 g) in a weight ratio of 80:20:1, and corresponds to a formula in which after the sugar powder is sifted, the egg white is mixed with the sugar powder, and the lemon juice is added. In this case, the output parameters include a nozzle size indicating a diameter of about 1.0 to 1.4 mm (preferably a diameter of about 1.2 mm) which is the first nozzle size, a flow of about 55% to 65% (preferably about 60%) which is the first flow, a nozzle temperature of about 24.5° C. to 25.4° C. (preferably about 25° C.) which is the sixth temperature, and a printing speed of about 25 mm/s to 35 mm/s (preferably about 30 mm/s) which is the first printing speed.

Here, there is a problem in that when the nozzle temperature is less than the sixth temperature range, the sugar powder coagulates, and when the nozzle temperature exceeds the sixth temperature range, the flowability of the egg white decreases, and thus an ingredient is not properly discharged through a nozzle. Meanwhile, there is a problem in that when the nozzle size is less than the first nozzle size range at a corresponding temperature, an ingredient is not discharged, and when the nozzle size exceeds the first nozzle size range, the icing is excessively discharged, which makes it difficult to manufacture a three-dimensional shape. In addition, when the printing speed is less than the first printing speed range at a corresponding nozzle temperature and nozzle size, a new layer is stacked in a state in which a previous layer has already been cured, which weakens an interlayer bonding force to cause a problem in that a structurally weak result is produced. In addition, when the printing speed exceeds the first printing speed range, a printer head may not place an ingredient at a correct position, and there may be a problem in that the surface quality and extrusion of the ingredient are non-uniform. At a corresponding nozzle temperature and nozzle size, when the flow is less than the first flow range, an amount and speed of an ingredient outputted through a nozzle are small, which causes a problem in that a lot of empty space is formed in a three-dimensional shape, and when the flow exceeds the first flow range, an excessive amount of the ingredient is output, which causes a problem in that the three-dimensional shape collapses.

### <Dairy Product Formulation and Optimal Output Parameters>

Hereinafter, a dairy product formulation and optimal output parameters will be described with reference to Table 5.

TABLE 5

| Output | | | |
|---|---|---|---|
| parameters/ | | | |
| formulation | Cream cheese | Butter | Butter cream |
| Nozzle size | First nozzle size (diameter | First nozzle size (diameter | First nozzle size (diameter |
| | of about 1.0 to 1.4 mm) | of about 1.0 to 1.4 mm) | of about 1.0 to 1.4 mm) |
| Flow | First flow (about 55% to | First flow (about 55% to | First flow (about 55% to |
| | 65%) | 65%) | 65%) |
| Nozzle temperature | Sixth temperature (about | Sixth temperature (about | Sixth temperature (about |
| | 24.5° C. to 25.4° C.) | 24.5° C. to 25.4° C.) | 24.5° C. to 25.4° C.) |
| Printing speed | First printing speed (about | First printing speed (about | First printing speed (about |
| | 25 mm/s to 35 mm/s) | 25 mm/s to 35 mm/s) | 25 mm/s to 35 mm/s) |

In an embodiment, the dairy product formulation includes a cream cheese formulation, and the cream cheese formulation consists of cream cheese. In this case, among output parameters, a nozzle size may be determined as a first nozzle size, a flow may be determined as a first flow, and a printing speed may be determined as a first printing speed.

Specifically, in an embodiment, the cream cheese formulation includes cream cheese (for example, about 200 g) as a single ingredient and corresponds to a formula in which when moisture is present, the moisture is removed, and the cream cheese is smoothly mixed. In this case, the output parameters include a nozzle size indicating a diameter of about 1.0 to 1.4 mm (preferably a diameter of about 1.2 mm) which is the first nozzle size, a flow of about 55% to 65% (preferably about 60%) which is the first flow, a nozzle temperature of about 24.5° C. to 25.4° C. (preferably about 25° C.) which is a sixth temperature, and a printing speed of about 25 mm/s to 35 mm/s (preferably about 30 mm/s) which is the first printing speed.

In another embodiment, the dairy formulation includes a butter formulation, and the butter formulation consists of butter. In this case, among the output parameters, the nozzle size may be determined as the first nozzle size, the flow may be determined as the first flow, and the printing speed may be determined as the first printing speed.

Specifically, in another embodiment, the butter formulation includes butter (for example, about 200 g) as a single ingredient, and corresponds to a formula in which when moisture is present, the moisture is removed, and the butter is smoothly mixed. In this case, the output parameters include a nozzle size a diameter of about 1.0 to 1.4 mm (preferably a diameter of about 1.2 mm) which is the first nozzle size, a flow of about 55% to 65% (preferably about 60%) which is the first flow, a nozzle temperature of about 24.5° C. to 25.4° C. (preferably about 25° C.) which is the sixth temperature, and a printing speed of about 25 mm/s to 35 mm/s (preferably about 30 mm/s) which is the first printing speed.

In another embodiment, the dairy product formulation includes a butter cream formulation, and the butter cream formulation consists of butter and sugar powder in a weight ratio of 2:1. In this case, among the output parameters, the nozzle size may be determined as the first nozzle size, the flow may be determined as the first flow, and the printing speed may be determined as the first printing speed.

Specifically, in another embodiment, the butter cream formulation includes butter (for example, about 60 g) and a sugar powder (for example, about 30 g) in a weight ratio of 2:1 as ingredients, and corresponds to a formula in which the sifted sugar powder and the butter are smoothly mixed with a spatula such that air bubbles are not introduced. In this case, the output parameters include a nozzle size indicating a diameter of about 1.0 to 1.4 mm (preferably a diameter of about 1.2 mm) which is the first nozzle size, a flow of about 55% to 65% (preferably about 60%) which is the first flow, a nozzle temperature of about 24.5° C. to 25.4° C. (preferably about 25° C.) which is the sixth temperature, and a printing speed of about 25 mm/s to 35 mm/s (preferably about 30 mm/s) which is the first printing speed.

All three dairy formulations described above have the same nozzle size, flow, nozzle temperature, and printing speed as optimal output parameters. When the nozzle size is less than a first nozzle size range, it is difficult for a formulation to be discharged through a nozzle, and when the nozzle size exceeds the first nozzle size range, it is difficult to form a desired three-dimensional shape. Here, when the flow is less than a first flow range, an amount and speed of an ingredient output through a printer head are small, which causes a problem in that a lot of empty space is formed in a three-dimensional shape, and when the flow exceeds the first flow range, an excessive amount of the ingredient is output, which causes a problem in that the three-dimensional shape collapses. Here, there is a problem in that when the nozzle temperature is less than a sixth temperature range, the flowability of an ingredient is not secured, and when the nozzle temperature exceeds the sixth temperature range, a dairy product deteriorates. Here, when the printing speed is less than a first printing speed range, an ingredient is exposed to heat or air inside a nozzle for a long time, which causes the ingredient to deteriorate. When the printing speed exceeds the first printing speed range, a printer head may not place an ingredient at a correct position, there may be a problem in that the surface quality and extrusion of the ingredient are non-uniform, and there may be a problem in that a result is not non-uniform and has a rough surface.

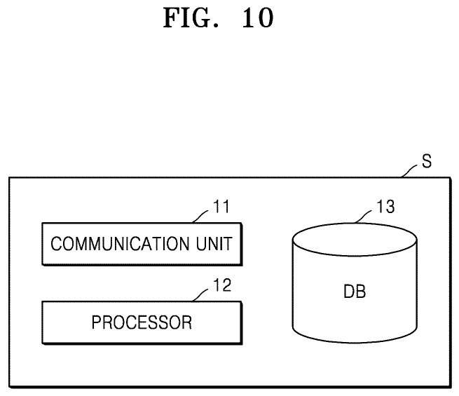

FIG. 10 is a block diagram of a platform server S according to an embodiment.

Referring to FIG. 10, the platform server S may include a communication unit 11, a processor 12, and a database (DB) 13. FIG. 10 illustrates only components of the server that are relevant to the embodiment. Accordingly, those skilled in the art may understand that other general-purpose components may be included in addition to the components shown in FIG. 10.

The communication unit 11 may include one or more components that enable wired/wireless communication with other nodes. For example, the communication unit 11 may include at least one of a short-range communication unit (not shown), a mobile communication unit (not shown), and a broadcast receiving unit (not shown).

The DB 13 may be hardware that stores various data processed in the server and may store a program for processing and controlling of the processor 12. The DB 13 may store a plurality of types of formulations, a formula (recipe) corresponding to each formulation, and optimal output parameters corresponding to each formulation. In addition, the DB 13 may store programs required for modeling and slicing, may store modeling files, or may store printing command data generated as a result of slicing. In addition, the DB 13 may store various operating systems and programs required for the operation of the server.

The DB 13 may include a random access memory (RAM) such as a dynamic random access memory (DRAM) or a static random access memory (SRAM), a read-only memory (ROM), an electrically erasable programmable read-only memory (EEPROM), a compact disk (CD)-ROM, a Blu-ray or other optical disk storage, a hard disk drive (HDD), a solid state drive (SSD), or a flash memory.

The processor 12 controls the overall operation of the server. For example, the processor 12 may control the overall operation of an input unit (not shown), a display (not shown), the communication unit 11, the DB 13, or the like by executing programs stored in the DB 1130. The processor 12 may control the operation of the server by executing the programs stored in the DB 13.

The processor 12 may be implemented by using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, and other electrical units for performing functions.

An embodiment according to the present disclosure may be implemented in the form of a computer program executable through various components on a computer. Such a computer program may be recorded on a computer-readable medium. In this case, examples of the computer-readable medium may include: magnetic media such as hard disks, floppy disks, and magnetic tapes; optical recording media such as compact disk-read only memories (CD-ROMs) and digital video disks (DVDs); magneto-optical media such as floptical disks; and hardware devices such as ROMs, random access memories (RAMs), and flash memories specifically configured to store program commands and execute the program commands.

Meanwhile, the computer program may be specially designed and configured for the present disclosure or may be known to and usable by usable by one of ordinary skill in the art of computer software. Examples of the computer program may include advanced language codes that may be executed by a computer by using an interpreter or the like as well as machine language codes made by a compiler.

According to an embodiment, methods according to various embodiments of the present disclosure may be included and provided in a computer program product. The computer program product may be traded as a product between a seller and a buyer. The computer program product may be distributed in the form of a machine-readable storage medium (for example, CD-ROM), or be distributed (for example, downloaded or uploaded) online via an application store (for example, PlayStore™), or between two user devices directly. When distributed online, at least a part of the computer program product may be temporarily generated or at least temporarily stored in the machine-readable storage medium, such as memory of the manufacturer's server, a server of the application store, or a relay server.

### INDUSTRIAL APPLICABILITY

A three-dimensional food printing system and a three-dimensional food printing method according to the present disclosure may be used in the restaurant and food service industries to develop customized dishes tailored to customer needs. In addition, the present system and method may be used to prepare special diets in the healthcare and imaging industries, and may contribute to providing a variety of foods in the fields of space and extreme environment exploration. In addition, the system and method of the present disclosure may contribute to an innovation in food design in the food manufacturing and processing industries, and may be utilized in the development and testing of various educational tools and recipes in the fields of education and research. In addition, the system and method of the present disclosure may be used in the event industries to develop and provide specially designed food.

What is claimed is:

1. A three-dimensional food printing method of a three-dimensional food printing system including a user terminal, a platform server, and a three-dimensional food printing device, the three-dimensional food printing method comprising:
receiving an input of a two-dimensional image from the user terminal;
generating a three-dimensional modeling file based on the input two-dimensional image;
receiving an input of a type of a formulation including food ingredients from the user terminal;
determining output parameters corresponding to the type of the formulation;
generating printing command data by performing slicing based on the determined output parameters and the generated three-dimensional modeling file; and
transmitting the printing command data to the three-dimensional food printing device,
wherein each operation is performed by the platform server.

2. The three-dimensional food printing method of claim 1, wherein the output parameters include at least one selected from the group consisting of a nozzle size, a flow, a nozzle temperature, and a printing speed.

3. The three-dimensional food printing method of claim 1, wherein the type of the formulation includes one selected from the group consisting of chocolate, dough, a fruit and vegetable paste, a sugar paste, and a dairy product.

4. The three-dimensional food printing method of claim 3, wherein the output parameters of the formulation include a nozzle size indicating a diameter of 0.5 mm to 1.5 mm, a flow of 45% to 75%, a nozzle temperature of 23° C. to 42° C., and a printing speed of 15 mm/s to 35 mm/s.

5. The three-dimensional food printing method of claim 4, wherein a formulation of the chocolate includes a couverture chocolate formulation;
the couverture chocolate formulation consists of tempered couverture chocolate in a first temperature range; and
among the output parameters, the nozzle temperature is determined as a second temperature that is lower than the first temperature range, the nozzle size is determined as a first nozzle size indicating a diameter of 1.0 mm to 1.4 mm, the flow is determined as a first flow of 55% to 65%, and the printing speed is determined as a first printing speed of 25 mm/s to 35 mm/s.

6. The three-dimensional food printing method of claim 5, wherein the formulation of the chocolate includes a semi-chocolate formulation;
the semi-chocolate formulation consists of tempered semi-chocolate in the first temperature range; and
among the output parameters, the nozzle temperature is determined as a third temperature that belongs to the first temperature range and is higher than the second temperature, the nozzle size is determined as the first nozzle size, the flow is determined as the first flow, and the printing speed is determined as the first printing speed.

7. The three-dimensional food printing method of claim 5, wherein the formulation of the chocolate includes a ganache formulation;
the ganache formulation consists of dark chocolate and heavy cream in a weight ratio of 2:1; and
among the output parameters, the nozzle temperature is determined as a fourth temperature that is lower than the second temperature, the nozzle size is determined as the first nozzle size, the flow is determined as a second flow that is lower than the first flow, and the printing speed is determined as the first printing speed.

8. The three-dimensional food printing method of claim 5, wherein a formulation of the dough includes a pasta dough formulation;
the pasta dough formulation consists of durum wheat flour, rice flour, and an egg in a weight ratio of 6:9:10; and
among the output parameters, the nozzle temperature is determined as a fifth temperature that is higher than the second temperature, among the output parameters, the nozzle size is determined as the first nozzle size, the flow is determined as the first flow, and the printing speed is determined as a second printing speed that is less than the first printing speed.

9. The three-dimensional food printing method of claim 5, wherein a formulation of the dough includes a cookie dough formulation;
the cookie dough formulation consists of cake flour, butter, sugar, an egg, and a baking powder in a weight ratio of 100:90:60:15:1; and
among the output parameters, the nozzle temperature is determined as a sixth temperature that is lower than the second temperature, among the output parameters, the nozzle size is determined as the first nozzle size, the flow is determined as the first flow, and the printing speed is determined as the first printing speed.

10. The three-dimensional food printing method of claim 5, wherein a
formulation of the fruit and vegetable paste includes a mashed potato formulation;
the mashed potato formulation consists of a potato powder and water in a weight ratio of 2:7; and
among the output parameters, the nozzle temperature is determined as a seventh temperature that is higher than the second temperature, among the output parameters, the nozzle size is determined as the first nozzle size, the flow is determined as the first flow, and the printing speed is determined as the first printing speed.

11. The three-dimensional food printing method of claim 5, wherein a formulation of the dairy product includes a cream cheese formulation;
the cream cheese formulation consists of cream cheese; and
among the output parameters, the nozzle temperature is determined as a sixth temperature that is lower than the second temperature, among the output parameters, the nozzle size is determined as the first nozzle size, the flow is determined as the first flow, and the printing speed is determined as the first printing speed.

12. The three-dimensional food printing method of claim 5, wherein a formulation of the dairy product includes a butter formulation;
the butter formulation consists of butter; and
among the output parameters, the nozzle temperature is determined as a sixth temperature that is lower than the second temperature, among the output parameters, the nozzle size is determined as the first nozzle size, the flow is determined as the first flow, and the printing speed is determined as the first printing speed.

13. The three-dimensional food printing method of claim 5, wherein a formulation of the dairy product includes a butter cream formulation;
the butter cream formulation consists of butter and a sugar powder in a weight ratio of 2:1; and
among the output parameters, the nozzle temperature is determined as a sixth temperature that is lower than the second temperature, among of the output parameters, the nozzle size is determined as the first nozzle size, the flow is determined as the first flow, and the printing speed is determined as the first printing speed.

14. A three-dimensional food printing system comprising:
a user terminal;
a platform server; and
a three-dimensional food printing device,
wherein the user terminal is configured to receive an input of a two-dimensional image from a user and receive an input of a type of a formulation including food ingredients,
the platform server is configured to generate a three-dimensional modeling file based on the two-dimensional image input from the user terminal, determine output parameters corresponding to the type of the input formulation, generate printing command data by performing slicing based on the selected output parameters and the generated three-dimensional modeling file, and transmit the generated printing command data, and
the three-dimensional food printing device is configured to print three-dimensional food based on the printing command data received from the platform server.
